(19) United States
(12) Patent Application Publication
(10) Pub. No.: US 2024/0183668 A1
(43) Pub. Date: Jun. 6, 2024

(54) Systems and Methods for Identifying High Traffic Zones and Suggesting Alternative Destinations to Users

(71) Applicant: Google LLC, Mountain View, CA (US)

(72) Inventors: Joseph L. Turner, San Mateo, CA (US); Stephen Rhys Norum, San Jose, CA (US)

(21) Appl. No.: 17/781,320

(22) PCT Filed: Feb. 7, 2022
(86) PCT No.: PCT/US2022/015405

§ 371 Date: May 31, 2022

(51) Int. Cl. G01C 21/34; G01C 21/36

(52) U.S. Cl. CPC G01C 21/3415; G01C 21/3492; G01C 21/3679; G01C 21/3691

(57) ABSTRACT

The present disclosure provides computer-implemented methods, systems, and devices for suggesting alternative destinations to users. A computing device receives location and movement data from a plurality of user computing devices. The computing device analyzes the location and movement data to determine one or more high traffic zones, each high traffic zone associated with a geographic location and one or more times. The computing device receives a navigation request including a starting location and an ending location. The computing device generates one or more candidate routes from the starting location and the ending location. The computing device determines, for each respective candidate route in the one or more candidate routes, whether the respective candidate route passes through a high traffic zone. The computing device selects a candidate route from the one or more candidate routes that does not pass through a high traffic zone.

The present disclosure relates generally to computer-based navigation. More particularly, the present disclosure relates to suggesting alternative destinations to users.

### BACKGROUND

As computer technology has improved, the number and type of services that can be provided to users have increased dramatically. The services provided via computer technology include navigation services. A navigation service can allow a user to navigate from a current position to a destination position. The user can submit a destination (e.g., an address) through an application associated with a navigation service. The navigation service can, using map data for a geographic area, generate a planned route to the destination. In some examples, the planned route includes one or more turn-by-turn navigation directions.

### SUMMARY

Aspects and advantages of embodiments of the present disclosure will be set forth in part in the following description, or can be learned from the description, or can be learned through practice of the embodiments.

One example aspect of the present disclosure is directed to a computing device. The computing device comprises one or more processors and a non-transitory computer-readable memory: wherein the non-transitory computer-readable memory stores instructions that, when executed by the one or more processors, cause the computing device to perform operations. The computing device receives location and movement data from a plurality of user computing devices. The computing device analyzes the location and movement data to determine one or more high traffic zones, each high traffic zone associated with a geographic location and one or more times. The computing device receives a navigation request including a starting location and an ending location. The computing device generates one or more candidate routes from the starting location and the ending location. The computing device determines, for each respective candidate route in the one or more candidate routes, whether the respective candidate route passes through a high traffic zone. The computing device selects a candidate route from the one or more candidate routes that does not pass through a high traffic zone.

Another aspect of the present disclosure is directed to a computing device. The computing device comprises one or more processors and a non-transitory computer-readable memory: wherein the non-transitory computer-readable memory stores instructions that, when executed by the one or more processors, cause the computing device to perform operations. The computing device receives a navigation request to a target destination from a user computing device, the target destination having one or more location characteristics. The computing device determines a user inconvenience score for the target destination based on the one or more location characteristics. In accordance with a determination that the user inconvenience score exceeds a predetermined threshold, identifying one or more alternative destinations, the computing device determines a user inconvenience score for each of the one or more alternative destinations. The computing device selects, based on the user inconvenience score for each of the one or more alternative destinations, a second destination from the one or more alternative destinations. The computing device transmits the second destination for display to a user.

Another aspect of the present disclosure is directed to a non-transitory computer-readable medium storing instructions that, when executed by one or more computing devices, cause the one or more computing devices to perform operations. The operations comprise receiving a navigation request to a target destination from a user computing device, the target destination having one or more location characteristics. The operations comprise determining a user inconvenience score for the target destination based on the one or more location characteristics. The operations comprise, in accordance with a determine that the user inconvenience score exceeds a predetermined threshold, identifying one or more alternative destinations. The operations comprise a user inconvenience score for each of the one or more alternative destinations. The operations comprise selecting, based on the user inconvenience score for each of the one or more alternative destinations, a second destination from the one or more alternative destinations. The operations comprise transmitting the second destination for display to a user.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing device according to example embodiments of the present disclosure:

FIG. 2 depicts an example server-client system according to example embodiments of the present disclosure:

FIG. 3 depicts an example navigation system according to example embodiments of the present disclosure:

FIG. 4 depicts an example user interface according to example embodiments of the present disclosure:

FIG. 5 depicts an example block diagram representing the steps for a method of determining alternative destinations for a target destination received from a user according to example embodiments of the present disclosure:

FIG. 6 depicts an example block diagram representing the steps for a method of gathering data to identify high traffic zones based on reported location data from user computing devices according to example embodiments of the present disclosure:

FIG. 7 depicts an example flow diagram for a method of suggesting alternative destinations to users according to example embodiments of the present disclosure; and

FIG. 8 depicts an example flow diagram for a method of determining high traffic zones and providing customized navigation information according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed towards a system for suggesting alternative destinations for users of a navigation application when an alternative that is more convenient or efficient for the user is identified. For example, a user may use a navigation application to access navigation information for a target destination (e.g., directions to a particular merchant or point of interest). In response, the navigation application can identify the target destination and determine one or more location characteristics. Location characteristics for the target destination can include information about the geographic position of the target destination, a location type of the target destination, as well as information about the hours of operation and an expected number of people (e.g., customers) or amount of busyness at the target destination.

The navigation application can determine a user inconvenience score for the target destination. The user inconvenience score can be based on the geographic position of the target destination, the location's hours of operation, an estimated busyness of the location, and so on. The user inconvenience score can be compared to an inconvenience threshold value. In some examples the inconvenience threshold value is predetermined. In other examples, an inconvenience threshold value can be determined by a user such that each user can determine their preferred amount of inconvenience before an alternative is proposed. If the user inconvenience score for the target destination exceeds the inconvenience threshold value, the navigation system can identify one or more alternative locations. In some examples, the alternative locations can be based on the geographic location of the target destination and/or business data for the target destination. For example, if the target destination is a merchant associated with a particular product or service, the navigation application can identify one or more other merchants within the geographic area that also provide the same product and/or service.

A user inconvenience score can be generated for each alternative location. One or more alternative destination can be selected for presentation. For example, the alternative destination with the lowest user inconvenience score can be selected. Once the alternative destination(s) is selected, the user can be provided with a prompt indicating that a less inconvenient location is available and allowing the user to switch their target destination if they so choose. If the user opts to change to one of the alternative destinations, the navigation application can generate navigation directions to the alternative destination chosen by the user.

For example, if a user enters a specific flower shop into the navigation application, the navigation application can generate a user inconvenience score for that flower shop. For example, if the user will arrive at the flower shop after or near the end of the flower shop's hours of operation, the navigation application can determine that the flower shop has a high user inconvenience score. The navigation application can access a database of locations and select one or more alternative destinations associated with flower shops. If the navigation application identifies at least one flower shop with a lower user inconvenience score than the original flower shop, the navigation application can display (or cause to be displayed) a prompt to determine whether the user would prefer to go to the alternative flower shop. If the user agrees, the navigation application can generate navigation instructions to the alternative flower shop.

In some examples, an objective measure of route/navigation efficiency can be used to select optimal routes to travel to a particular location. In this context, the navigation application can receive, from a plurality of user computing devices, location and motion data associated with each user computing device. This information may only be gathered if the user explicitly consents to it. The location and motion data from the one or more user devices can be collected and analyzed. An analysis system associated with the navigation application can determine, based on the analyzed location and motion data, one or more zones with high traffic. As increasing amounts of data are collected, the location and motion data can be analyzed to determine periodic schedules in which particular locations experience high traffic (e.g., pedestrian traffic, vehicular traffic, and so on) at particular times.

One example can be schools. In some examples, user computing devices associated with school attendance can be identified (with user permission). By determining when user computing devices are moving and their location, the navigation application can determine the times and locations in which school zones have the most traffic (e.g., students arriving, leaving, or moving between classes). This information can be stored in a navigation database, such that the specific locations and times associated with high traffic zones are available to a navigation application.

When a navigation application receives a navigation request from an initial location to an ending location, the navigation application can generate one or more potential routes. A score can be generated for each route to identify the most optimal route for a user. A route may be considered most optimal or most efficient if, for example, the route allows the user to arrive at the ending location in the fastest time. Other measures may be used, such as the route that requires the least fuel consumption or fewest turns, for example. In this example, as a high traffic zone would negatively impact the efficiency of the route, the navigation application can reduce the score of any route that passes through a high traffic zone at the time in which it is high traffic. Thus, routes that do not travel through high traffic zones can be preferred to, and more efficient than, routes that do travel through high traffic zones. In addition to regularly repeating high traffic zones such as school zones, the navigation application can track live high traffic zones such as concerts, sporting events, and so on. This real-time high traffic zone data can be used to update the route preferences of the navigation application in real-time to allow real-time optimization of navigation routes.

In a specific example, users at a particular school can consent to have their location and movement data anonymized and reported to a server associated with the navigation application. The server can then use this information to determine the times at which students are out of class and traveling around and near the school campus. The times that students are actually out of class and moving around campus can differ from the official times of the school because of after-school activities and so on. Once the navigation application has determined the times and places in which the movement of students onto the campus, off of the campus, or around the campus causes a high traffic zone, that time and location can be recorded in a database of navigation data.

If a user requests navigation information from the navigation application, the navigation application can discount and/or disincentivize any route that travels through the high traffic zone associated with the school. By routing vehicles around the school zone during high traffic times, the navigation application can improve the experience of drivers (who will experience fewer delays), improve route efficiency and improve the safety of the students and user in the high traffic zone associated with the school.

More generally, a computing device can include a user computing device. A user computing device can be any computing device that is designed to be operated by an end-user. For example, a user computing device can include, but is not limited to, personal computers, smartphones smartwatches, fitness bands, tablet computers, laptop computers, and so on. In some examples, a user computing device can include one or more sensors intended to gather information with the permission of the user such as location information.

A navigation application can be any application configured to provide navigation information to a user upon request. For example, a navigation application can provide turn-by-turn directions from a starting location to an ending location. A navigation application can also allow a user to search for particular points of interest in a geographic location. For example, a user can submit a query (e.g., using keywords) to the navigation application along with a specific geographic location. In response to the received query, the navigation application can generate a list of one or more candidate points of interest that match both the query and the geographic location. For example, a user can submit a query for “grocery stores” near the user's current location, and a navigation application can respond with a list of candidate matches near the current location of a user. In addition, the navigation application can provide navigation directions to one or more of the candidate locations.

In some examples, the navigation application can receive queries from a user and provide, via a display, navigation directions that respond to the user's query by providing turn-by-turn directions from an initial position to a destination. In some examples, the navigation application can communicate over a network to a server system that stores map and navigation information. The server system can, in response to the received user query, provide the requested map and/or navigation information to the navigation application for display to the user.

In some examples, the navigation application can receive, from a user, a request for navigation directions to a target destination. The target destination can be a merchant location or another point of interest. In some examples, the target destination can have one or more location characteristics. The location characteristics can be information that describes the geographic position of the target destination, the location type of the target destination, information describing the hours of operation of the target destination, the average amount of user traffic present at the location at one or more times or dates, and so on.

In some examples, when the navigation application receives a request to travel to a target destination, the navigation application can determine a user inconvenience score for the target destination. The user inconvenience score can represent the amount of inconvenience a user is expected to experience traveling to or at the target destination. In some examples, the user inconvenience score can be based on one or more location characteristics. In some examples, the user inconvenience score can be based on the hours of operation of a particular merchant. For example, if the user's expected arrival time is near or after the end of the hours of operation for the target destination, the user's inconvenience score for the target destination may be high. If the user is planning to arrive at a time when the target destination has high traffic (e.g., is very busy) the user inconvenience score can be increased to represent the additional inconvenience.

Once the user inconvenience score has been generated it can be compared against an inconvenience threshold value. The inconvenience threshold value can represent an estimated amount of inconvenience associated with a location at which the navigation system will begin proposing alternative locations. In some examples, the inconvenience threshold value is fixed and the same for all users. In other examples, each user can set the inconvenience threshold value such that their own personal preferences can determine when an alternative location is suggested.

If the user inconvenience score for the target destination exceeds an inconvenience threshold value, the navigation application can identify one or more alternative destinations. In some examples, the navigation application determines alternative destinations based on one or more location characteristics of the target destination. For example, alternative destinations can be determined based on the geographic position of the target destination, the location type of the target destination, and one or more user preferences. In some examples, the location type can be a merchant. The merchant may have one or more product types or service types with which they are associated. If so, the navigation application can identify merchant locations that provide the same goods or services as the target destination.

Once a plurality of alternative destinations are determined, the navigation application can generate, for each alternative destination, a user inconvenience score. In some examples, the navigation application will discard any alternative destinations with a user inconvenience score that exceeds the user inconvenience score of the target destination. In some examples, the navigation application can select an alternative destination with the lowest user inconvenience score. Additionally, or alternatively, the navigation application can select all alternative destinations that have a user inconvenience score that is better than the user inconvenience score of the target destination by a predetermined amount.

Once one or more alternative destinations have been selected the navigation application can transmit the alternative destinations to a user computing device for display. A user can select one or more of the alternative destinations and in response, their associated user device can transmit an indication that the user has accepted the alternative destination. Upon receiving a notification that the user has selected an alternative destination, the navigation application can generate updated navigation information to the selected alternative destination.

The navigation application can also gather information from user computing devices with the consent of the user. For example, each user computing device can include one or more sensors that detect the current geographical location and the movement of the user computing device. The user computing device can include a global positioning system (GPS) that allows the user computing device to determine its current location and one or more gyroscopes or accelerometers that can measure movement. If the user consents, this information can be transmitted to a server associated with the navigation application.

In some examples, the navigation application can analyze the location and movement data. Analyzing the data can include grouping users based on the specific event or location at that location. In some examples, this information can be based on existing user profiles. For example, users known to attend the same school or work at the same business can be grouped or otherwise associated by the navigation application. In other examples, the users' commercial activities such as buying tickets or subscribing to a membership with a specific location can be analyzed, with the user's permission, and used to determine an event or location associated with the user.

Once the location and movement data have been analyzed and the users have been grouped into a group based on common events or common locations, the navigation application can determine one or more high traffic zones. A high traffic zone can be a location at a time associated with higher-than-average user traffic. For example, a sporting event can result in a large increase in the amount of foot and vehicle traffic before and after the sporting event. During these times a large number of attendees will enter the stadium (before the event) or exit the stadium and travel to their vehicles (after the event). In some examples, high traffic zones can be recurring events such as the time students typically move around the school grounds or building on school days. In some examples, determining the times in which users are actively moving around a space can be used to determine high traffic zones and times when the official hours associated with the location are not as accurate in determining the high traffic zone and times.

Once the high traffic zones and times are determined, the navigation application can receive a request for navigation information for a specific destination. In responding to the navigation request, the navigation application can determine one or more potential routes from a starting location to the specific destination. Each potential route can be evaluated to determine the optimal route. Routes that travel through a high traffic zone in the time in which it is known to be high traffic can be determined to be less optimal than other routes. For example, these routes can be discounted by the navigation system. As a result, the navigation application is less likely to recommend these routes to the user and instead prefers routes that do not pass through a high traffic zone, thereby improving navigation efficiency as previously described.

The systems and methods of the present disclosure provide a number of technical effects and benefits. As one example, the proposed systems can provide for automatically recommending an alternative location for a user when the original location might result in inconvenience to the user. Automatically accessing data about a location and identifying potential alternative destinations enables a navigation application to provide more efficient navigation services to a user. Improving the effectiveness of navigation applications can reduce the amount of storage needed and energy used when providing navigation information. Further, a more efficient navigation service can provide faster and/or more fuel-efficient routes for the user. Reducing the amount of storage needed and energy used reduces the cost of the navigation service associated with the navigation application and improves the user experience. This represents an improvement in the functioning of the device itself.

With reference now to the Figures, example embodiments of the present disclosure will be discussed in further detail.

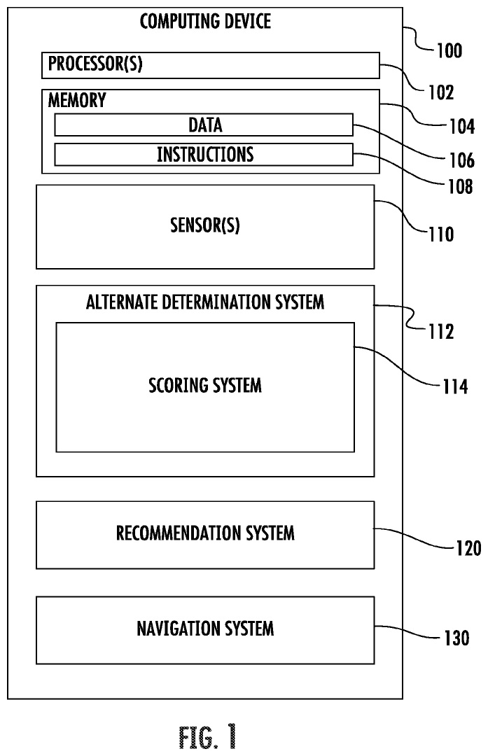

FIG. 1 depicts an example computing device 100 according to example embodiments of the present disclosure. In some example embodiments, the computing device 100 can be any suitable device, including, but not limited to, a smartphone, a tablet, a laptop, a desktop computer, a global positioning system (GPS) device, a computing device integrated into a vehicle, or any other computing device that is configured such that it can allow a person to execute a navigation application or access a navigation service at a server computing system. The computing device 100 can include one or more processor(s) 102, memory 104, one or more sensors 110, an alternative destination determination system 112, a high traffic determination system 116, a recommendation system 120, and a navigation system 130.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store information accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the alternative destination determination system 112, the recommendation system 120, and the navigation system 130. The computing device 100 can implement the alternative destination determination system 112, the recommendation system 120, and the navigation system 130 to execute aspects of the present disclosure, including determining one or more alternative destinations based on a first destination, evaluating the alternative destinations, presenting one or more to the user, and providing navigation services (e.g., turn-by-turn directions, location-based searching, and so on) to a user.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as map data associated with the navigation system 130 (e.g., data representing a geographic area including one or more roads and a one or locations of interest received from a server system), that can be retrieved, manipulated, created, or stored by the one or more processor(s) 102. In some example embodiments, such data can be accessed and displayed to a user of the computing device 100 (e.g., during use of a navigation system 130) or transmitted to a server computing system as needed.

In some example embodiments, the computing device 100 includes an alternative destination determination system 112, a high-traffic determination system 116, a recommendation system 120, a navigation system 130. The alternative destination determination system 112, the high-traffic determination system 116, and the recommendation system 120 can act to support the navigation system 130 by identifying potential alternative destinations and recommending them to the user to improve the user's experience and identifying high-traffic zones to avoid while the navigation system 130 is providing navigation information.

For example, in response to the navigation system 130 receiving a target destination from a user (e.g., a user enters an address of a business, point of interest, and so on), the alternative destination determination system 112 can, using the scoring system 114, determine a user inconvenience score for the target destination. As noted below, the scoring system 114 can use a variety of types of information about a location to determine a user inconvenience score. Such information can include the geographic location of the target destination, the associated hours of operations, an expected level of busyness, and so on. If the user inconvenience score exceeds an inconvenience threshold value, the alternative destination determination system 112 can identify one or more alternative destinations that have one or more features similar to the original target destination. Each alternative destination can be evaluated (e.g., can be scored by the scoring system) and the recommendation system 120 can select one or more alternative destinations to recommend to the user.

The one or more selected alternative destinations can be displayed (or transmitted for display) to a user in the interface of the navigation application. For example, a user can enter an address for a tire shop. In response, the navigation application can determine that the initially entered tire shop is about to close, the navigation application can identify an alternative tire shop. The alternative tire shop can be displayed in an interface of the navigation application as a drop-down prompt or a pop-up prompt.

In some examples, the prompt can include an explanation describing why the alternative destination is being displayed. For example, the prompt could read “Tire shop 1 will close within 5 minutes of your arrival, would you prefer to travel to Tire shop 2 which is open until 9 pm?” Thus, a user can evaluate the alternative destination based on the reason the alternative is being suggested.

Thus, the alternative destination determination system 112 can enable the suggestion of alternative destinations for a user. In some examples, the alternative destination determination system 112 can evaluate a location entered by a user into a navigation application or service. The location can be entered based on an address or another identifier of a location (e.g., the name of a specific store). The alternative destination determination system 112 can access location characteristic information about the target destination. In some examples, the alternative destination determination system 112 can access the location characteristic information from an associated navigational database. The navigational database can include the geographic position of the location, the type of the location, average number of people or customers at that location at a particular date and at specific times, the hours of operation of the location, the goods and services available at the location (if any), and so on.

The alternative destination determination system 112 can provide the target destination and any location characteristic information to the scoring system 114. The scoring system 114 can generate a user inconvenience score for the target location based on one or more location characteristics and/or any information about the user that the user provided. In some examples, a plurality of factors can be used when generating a user inconvenience score. Factors can include, but are not limited to, the distance from the user to the location, the expected travel time between the user and the location, the operating hours of the location, the estimated busyness of the location, the accessibility of the location (based, in part, on the accessibility interests of the user), the estimated amount of a particular good in stock or the availability of a particular service, and so on.

In some examples, a user inconvenience score can be generated by generating a value (e.g., a normalized value between 0) and 1) for each factor, weighting those factors, and combining them to reach a final user inconvenience score. In other examples, the location characteristic data can be used to generate one or more features that can be used as input to a machine-learned model.

The alternative destination determination system 112 can receive a user inconvenience score for the target destination from the scoring system 114. The alternative destination determination system 112 can compare the user inconvenience score to an inconvenience threshold value. The inconvenience threshold value can be a score at which the inconvenience to the user is significant enough that the system will identify alternatives. In some examples, the user inconvenience score for the target location can be determined to exceed the inconvenience threshold value. In response, the alternative destination determination system 112 can identify one or more alternative destinations.

For example, alternative destinations can be determined based on the geographic position of the target destination, the location type of the target destination, and one or more user preferences. In some examples, the location type can be a store or merchant. The store or merchant may have one or more products or services with which they are associated. If so, the alternative destination determination system 112 can identify business or merchant destinations that provide the same goods or services as the first destination.

Once a plurality of alternative destinations are determined, the alternative destination determination system 112 can generate, for each alternative destination, an user inconvenience score. As noted above, the scoring system 114 can be used to determine a user inconvenience score for each alternative destination.

In some examples, the alternative destination determination system 112 can discard any alternative destination with a user inconvenience score that exceeds the user inconvenience score of the target destination. Once the alternative destination determination system 112 has, using the scoring system 114, determined a user inconvenience score for each alternative destination, the alternative destinations and the associated user inconvenience scores can be passed to the recommendation system 120.

In some examples, the recommendation system 120 can select an alternative destination with the lowest user inconvenience score. Additionally, or alternatively, the recommendation system 120 can select all alternative destinations that have a user inconvenience score that is better than the user inconvenience score of the target destination by a predetermined amount.

Once one or more alternative destinations have been selected, the recommendation system 120 can transmit the alternative destinations to a user computing device for display. A user can select one or more of the alternative destinations and in response, their associated user device can transmit an indication that the user has accepted the alternative destination. Upon receiving a notification that the user has selected an alternative destination, the navigation system 130 can generate updated navigation information to the selected alternative destination.

A high traffic determination system 116 can determine one or more high traffic zones. These high traffic zones can be identified using location and movement data received, with user permission, from a plurality of users. Specifically, the high-traffic zones can represent areas in which, at a particular time/date, significantly higher than normal density of traffic will be expected. In addition, the high-traffic zones can be determined based on the type or source of the traffic. For example, high-traffic zones can be school zones during the times in which students are most likely to be traveling to or from the school. These high-traffic zones can be determined to avoid extra delay for users and improve safety for persons in the high traffic zones (e.g., students at school, concert attendees leaving a venue, parade attendees on a particular holiday, and so on).

The recommendation system 120 can use the determined high-traffic zone to recommend more optimal and efficient routes that avoid the high traffic zones if possible. For example, if a request to travel to a particular destination is received, the recommendation system 120 can discount or otherwise disincentivize any candidate routes that travel through a determined high traffic zone.

The navigation system 130 can provide, in a display, a visual depiction of a geographic area. The visual depiction of the geographic area can include one or more streets, one or more points of interest (including buildings, landmarks, and so on), and a highlighted depiction of a planned route. In some examples, the navigation application 130 can also provide location-based search options to identify one or more searchable points of interest within a given geographic area. In some examples, the navigation system 130 can include a local copy of the relevant map data. In other examples, the navigation system 130 can access information at a remote server computing system to provide the requested navigation services.

In some examples, the navigation system 130 can be a dedicated application specifically designed to provide navigation services. In other examples, the navigation system 130 can be enabled by a general application (e.g., a web browser) that can provide access to a variety of different services including a navigation service via a network.

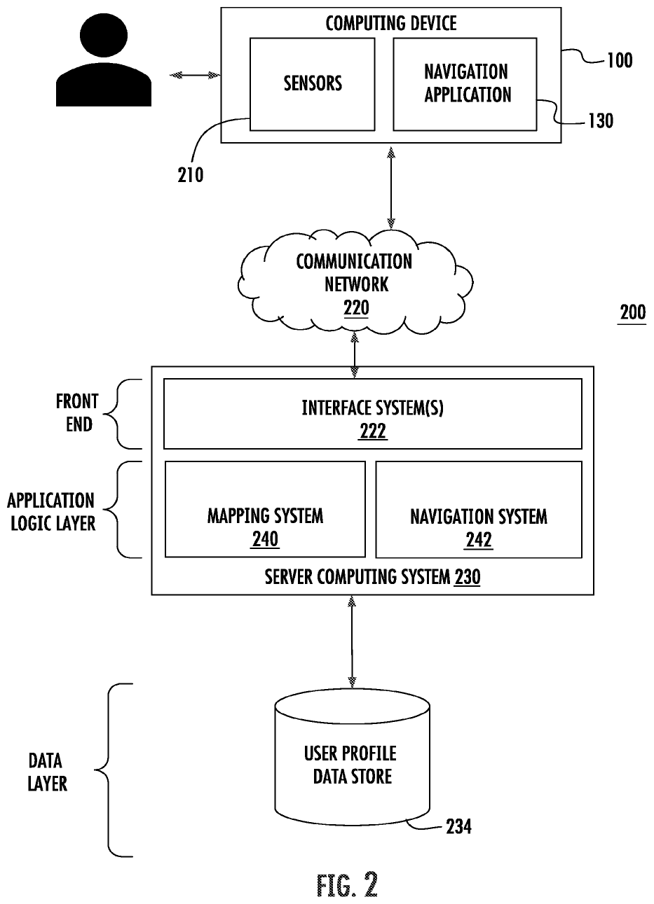

FIG. 2 depicts an example client-server environment 200 according to example embodiments of the present disclosure. The client-server system environment 200 includes one or more user computing devices 100 and a server computing system 230. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks.

A user computing device 100 can include, but is not limited to, smartphones, smartwatches, fitness bands, navigation computing devices, laptops computers, embedded computing devices (computing devices integrated into other objects such as clothing, vehicles, or other objects). In some examples, a user computing device 100 can include one or more sensors intended to gather information with the permission of the user associated with the user computing device 100.

In some examples, the user computing device 100 can connect to another computing device, such as a personal computer (PC), a laptop, a smartphone, a tablet, a mobile phone, an electrical component of a vehicle, or any other electric device capable of communication with the communication network 220. A user computing device 100 can include one or more application(s) such as search applications, communication applications, navigation applications 130, productivity applications, game applications, word processing applications, or any other applications. The application(s) can include a web browser. The user computing device 100 can use a web browser (or other application) to send and receive requests to and from the server computing system 230. The application(s) can include a navigation application 130 that enables the user to send navigation requests to the server computing system 230 and receive navigation information in response.

In some examples, the user computing device 100 can include one or more sensors 210 that can be used to determine information, with the express permission of the user, associated with the environment of the user computing device 100 or information associated with the user of the user computing device 100 (such as the position or movement of the user). In some examples, the sensors 210 can include a motion sensor to detect movement of the device or the associated user, a location sensor (e.g., a GPS) to determine the current location of the user computing device 100, an audio sensor to gather audio information in the area of the user computing device 100.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more user computing devices 100 and communicates appropriate responses to the user computing devices 100. For example, the interface system(s) 222 may receive requests in the form of Hypertext Transfer Protocol (HTTP) requests, or other web-based, application programming interface (API) requests. The user computing devices 100 may be executing conventional web browser applications or applications that have been developed for a specific platform to include any of a wide variety of computing devices and operating systems.

As shown in FIG. 2, the data layer can include a geographic data store 234. The geographic data store 234 can store a variety of navigation data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings if any are at that location). Similarly, a user can enter the name of a location or point of interest and the system can identify the address associated with that location.

In some examples, the geographic data store 234 can include information that is associated with location determining systems such as the global positioning system (GPS) such that the location of a specific computing device can be determined with respect to the map data. The geographic data store 234 can include direction data that can allow the navigation system 130 to generate routes between any two locations represented in the map data. In some examples, the geographic data store 234 can include location characteristic information about a plurality of locations. As noted above, the location characteristic information can include the address of the location, the geographic position of the location, the type of the location, the average amount of people at that location at particular dates and times, the hours of operation of the location, the goods and services available at the location (if any), and so on.

In some examples, the geographic data store 234 can also include image data, the image data associated with one or more geographic areas. The navigation data store can also include satellite image data associated with one or more geographic areas.

The application logic layer can include application data that can provide a broad range of other applications and services that allow users to access or receive geographic data for navigation or other purposes. The application logic layer can include a mapping system 240 and a navigation system 242.

The mapping system 240 can, in response to queries received from one or more users, identify one or more search results, the search results being associated with particular geographic locations. For example, a user computing device 100 can submit a search query for “grocery stores” along with a geographic location. The mapping system 240 can generate a list of search results that match the query terms near the geographic location. The search results can be ranked or ordered based on the quality of the match between the search terms and the results, the distance from the geographic location and the location associated with the search result, or a combination of both.

A navigation system 242 can provide, for display, data enabling a visual depiction of a geographic area. The visual depiction of the geographic area can include one or more streets, one or more points of interest (including buildings, landmarks, and so on), and a highlighted depiction of a planned route. The navigation system 242 can receive, via the interface, a navigation request query including an initial location and a target destination. The navigation system 242 can generate a navigation route from the initial location to the target destination.

In some examples, the navigation system 242 can receive a request from a user computing device to generate our route to a target destination. The navigation system 242 can generate a user inconvenience score for the target destination based on data stored about the target destination in the geographic data store 234. The user inconvenience score can represent the amount of inconvenience that may be faced by a user traveling to that destination. For example, if the target destination is known to be busy, near closing time, low on stock, or having accessibility issues, the user inconvenience score for that location destination can be high.

In some examples, the navigation system 242 can compare the determined user inconvenience score for the target location to an inconvenience threshold value. The inconvenience threshold value can represent the level at which inconvenience is so great that the navigation system 242 determines whether an alternative destination is available. As noted above, the inconvenience threshold value can be predetermined such that the threshold value is the same for all users. In other examples, users can adjust the inconvenience threshold value such that they can receive alternative recommendations more or less often.

If the navigation system 242 determines that the user inconvenience score exceeds the inconvenience threshold value, the navigation system 242 can identify one or more alternative destinations. Alternative destinations can be determined based on the characteristics of the target destination and comparing those against one or more locations in the geographic area of the target destination. For example, the target destination is a store or merchant location that offers a particular service. Alternative destinations can be stores that offer the same service and are within a certain threshold distance of the target destination or the initial starting point of the user.

Each of the one or more alternative destinations can be evaluated to determine user inconvenience scores for those alternative destinations. Alternative destinations with a user inconvenience score that exceeds that of the original target destination can be discarded. The navigation system 242 can select one or more alternative destinations based on the user inconvenience scores with each alternative destination. The selected one or more alternative solutions can be transmitted to the user computing device 100 display to a user and an interface. The user can choose to accept the recommendation or reject it. If the recommendation is accepted, the navigation system 242 can generate directions to the alternative destination.

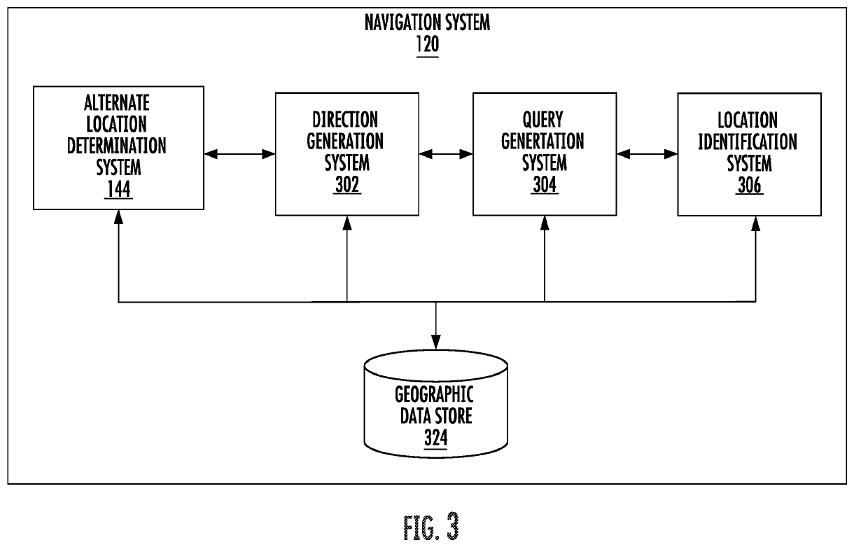

FIG. 3 illustrates an example navigation system 130 in accordance with example embodiments of the present disclosure. The navigation system 130 can include an alternative destination determination system 112, a direction generation system 302, a query generation system 304, and a location identification system 306.

For example, the navigation system 130 can receive, from a user, a request for navigation directions to a target destination. The target destination can be a merchant location or another point of interest. In some examples, the target destination can have one or more location characteristics. The location characteristics can be information that describes the geographic position of the target destination, the location type of the target destination, information describing the hours of operation of the target destination, the average amount of user traffic present at the location at one or more times or dates, and so on.

In some examples, when the navigation system 130 receives a request to travel to a target destination, the alternative destination determination system 112 can determine a user inconvenience score for the target destination. The user inconvenience score can represent the estimated amount of inconvenience a user will experience traveling to or at the target destination. For example, in some examples, the user inconvenience score can approximate an amount of delay (such that the score is increased by traffic congestion, location business, lack of stock, and the end of hours of operation.) In other examples, the user inconvenience score does not correlate to a specific real-world measurement, but instead represents a likelihood that the user will have a negative experience. Such a likelihood can be determined based on examples cases in collected data. For example, if a user experiences long delays, leave negative reviews, and/or have to travel to another destination to accomplish their goals, this data can be gathered and used to design a user inconvenience algorithm (by collecting particular factors determined to be important and weighting them to give accurate scores) or used to train a machine-learned model that estimates user inconvenience based on location characteristic data used as input and outputs a user inconvenience score.

For example, the user inconvenience score can be based on one or more location characteristics. In some examples, the user inconvenience score can be based on the hours of operation of a particular merchant. For example, if the user's expected arrival time is near or after the end of the hours of operation for the target destination, the user's inconvenience score for the target destination may be high. If the user is planning to arrive at a time when the target destination has high traffic (e.g., is very busy) the user inconvenience score can be increased to represent the additional inconvenience.

Once the user inconvenience score has been generated, the alternative destination determination system 112 can compare the score against an inconvenience threshold value. The inconvenience threshold value can represent an estimated amount of inconvenience associated with a location at which the navigation system will begin proposing alternative locations. In some examples, the inconvenience threshold value is fixed and the same for all users. In other examples, each user can set the inconvenience threshold value such that their own personal preferences can determine when an alternative location is suggested.

If the user inconvenience score for the target destination exceeds an inconvenience threshold value, the alternative destination determination system 112 can identify one or more alternative destinations. In some examples, the navigation application determines alternative destinations based on one or more location characteristics of the target destination. For example, alternative destinations can be determined based on the geographic position of the target destination, the location type of the target destination, and one or more user preferences. In some examples, the location type can be a merchant. The merchant may have one or more products with which they are associated. If so, the navigation application can identify merchant locations that provide the same goods or services as the target destination.

Once a plurality of alternative destinations are determined, the alternative destination determination system 112 can generate, for each alternative destination, a user inconvenience score. In some examples, the alternative destination determination system 112 can discard any alternative destinations with a user inconvenience score that exceeds the user inconvenience score of the target destination. In some examples, the alternative destination determination system 112 can select an alternative destination with the lowest user inconvenience score. Additionally, or alternatively, the navigation application can select all alternative destinations that have a user inconvenience score that is better than the user inconvenience score of the target destination by a predetermined amount.

Once one or more alternative destinations have been selected the navigation system 130 can transmit the alternative destinations to a user computing device 100 for display. A user can select one or more of the alternative destinations and in response, their associated user device can transmit an indication that the user has accepted the alternative destination. Upon receiving a notification that the user has selected an alternative destination, the navigation application can generate updated navigation information to the selected alternative destination.

The direction generation system 302 can provide directions to a specific location. For example, a user can input a destination location (e.g., an address). In response, the navigation application 130 can, using locally stored map data for a specific geographic area, provide navigation information allowing the user to navigate to the destination location. The navigation information can include turn-by-turn directions from a current location (or a provided location) to the destination location. The direction generation system 302 can select from a plurality of possible routes from the current location to the destination location based on one or more criteria.

The query generation system 304 can generate queries based on input from the user. In some examples, the query generation system 304 can automatically customize the query based on information determined about the user, the query, and/or the current vehicle of the user. For example, if the vehicle type of the current vehicle is known, the query generation system 304 can modify or customize the query to represent the vehicle type of the current vehicle.

The location identification system 306 can determine a current location for a navigation system 130. It can do so based on location information generated by sensors included in a computing device (e.g., computing device 100 in FIG. 1). In some examples, a global positioning system (GPS) can provide the location information.

In some example embodiments, the geographic data store 324 can store a variety of navigation data. For example, the geographic data store 324 can include map data. In some examples, the map data can include a series of sub-maps, each sub-map including data for a geographic area including objects (e.g., buildings or other static features), paths of travel (e.g., roads, highways, public transportation lines, walking paths, and so on), and other features of interest. The geographic data store 324 can also include image data, the image data associated with one or more geographic areas. The geographic data store 234 can also include satellite image data associated with one or more geographic areas.

In some examples, the geographic data store 324 can include data describing one or more high traffic zones. The high traffic zones can be determined based on location and movement data received from one or more user computing devices. With the permission of a user, the data can be analyzed to determine high traffic zones, representing areas with repeating incidents of high traffic (e.g., congestion) or areas of high caution (e.g., school zones when children are leaving or entering). In addition, the geographic data store 324 can include data representing high traffic associated with currently occurring events (e.g., concerts, graduation ceremonies, and so on).

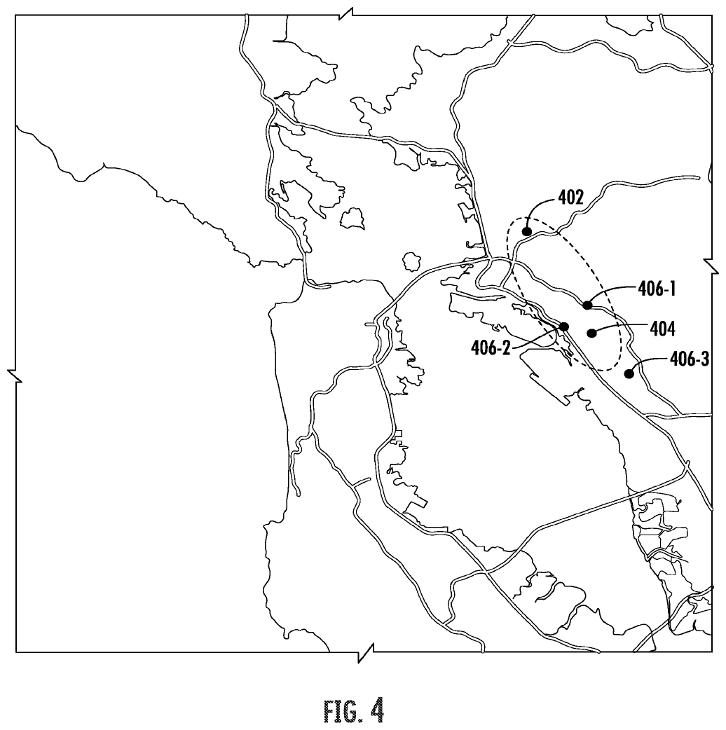

FIG. 4 depicts an example user interface according to example embodiments of the present disclosure. In this example, a user has requested directions from a first location 402 to a target destination 404. The navigation system 130 can determine an estimated user inconvenience score for the target destination 404. If the user inconvenience score exceeds a threshold value, the navigation system 130 can determine one or more alternative destination locations.

In this example, the alternative destinations can include 406-1, 406-2, and 406-3. each alternative destination can be evaluated to determine whether or not to recommend it to the user. In some examples, one of the alternative destinations 406-3 can be discarded for being too far from the initial location and the target destination.

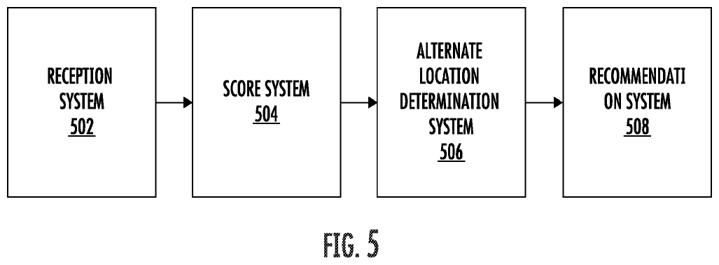

FIG. 5 depicts an example block diagram representing the steps for a method of determining alternative destinations for a target destination received from a user according to example embodiments of the present disclosure. In some examples, a reception system 502 can receive, from a user, a target destination. With the navigation application 130 and generate a route from the user's current location to the target destination. In the scoring system 504 can generate a user inconvenience score for the target destination.

In some examples, if the user inconvenience score exceeds an inconvenience threshold value, an alternative location determination system 506 can generate a list of one or more alternative destinations. In some examples, the alternative location determination system 506 can generate a user inconvenience score for each of the one or more alternative locations.

In some examples, the recommendation system 508 can select one or more of the alternative destinations. In some examples, the recommendation system 508 selects the alternative destination based on the generated user inconvenience scores for each of the alternative locations.

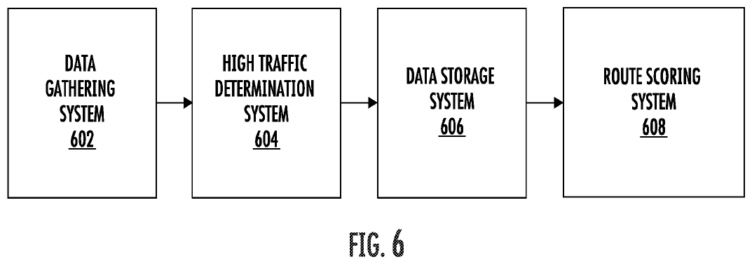

FIG. 6 depicts an example block diagram representing the steps for a method of gathering data to identify high traffic zones based on reported location data from user computing devices according to example embodiments of the present disclosure.

A data gathering system 602 can gather information from user computing devices with the consent of the user. For example, each user computing device can include one or more sensors that detect the current geographical location and the movement of the user computing device. For example, the user computing device can include a global positioning system (GPS) that allows the user computing device to determine its current location and one or more gyroscopes or accelerometers that can measure movement. If the user consents, this information can be anonymized and transmitted to a navigation server associated with the navigation application.

In some examples, a high traffic determination system 604 can analyze the data. Analyzing the data can include grouping users based on the specific event or location at that location. In some examples, this information can be based on existing user profiles. For example, users known to attend the same school or work at the same business can be grouped or otherwise associated by the navigation application. In other examples, the users' commercial activities such as buying tickets or subscribing to a membership with a specific location can be analyzed, with the user's permission, and used to determine an event or location associated with the user.

Once the location and movement data have been analyzed and the users have been grouped into a group based on common events or common locations, the high traffic determination system 604 can determine one or more high traffic zones. A high traffic zone can be a location at a time associated with higher-than-average user traffic. For example, a sporting event can result in a large increase in the amount of foot and vehicle traffic before and after the sporting event. During these times a large number of attendees will enter the stadium (before the event) or exit the stadium and travel to their vehicles (after the event). In some examples, high traffic zones can be recurring events such as the time students typically move around the school grounds or building on school days. In some examples, determining the times in which users are actively moving around a space can be used to determine high traffic zones and times when the official hours associated with the location are not as accurate in determining the high traffic zone and times.

Once the high traffic zones and times are determined, the data storage system 606 can store data representing one or more high traffic zones, including the times/date and location at which each high traffic zone occurs. The navigation system 130 can receive a request for navigation information for a particular destination. In responding to the navigation request, the navigation system 130 can determine one or more potential routes from a starting location to the particular destination. Each potential route can be scored (or otherwise evaluated) by the route scoring system 608 to determine the optimal and most efficient route. Routes that travel through a high traffic zone in the time in which it is known to be high traffic can be determined to be less optimal than other routes by the route scoring system 608. As a result, the navigation application is less likely to recommend these routes to the user and instead prefers more efficient routes that do not pass through a high traffic zone.

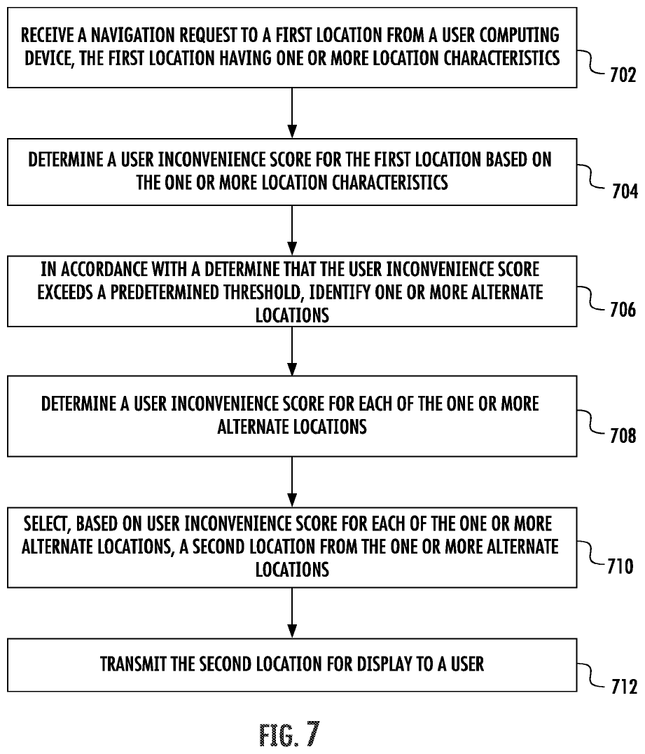

FIG. 7 depicts an example flow diagram for a method of suggesting alternative destinations to users according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing device (e.g., computing device 100 in FIG. 1) can include one or more processors, memory, and other components that, together, enable the computing device to suggest alternative destinations to users. In some examples, the computing device is a portable computing device, such as a smartphone or tablet computer. The computing device can receive, at 702, a navigation request to a target destination from a user computing device, the target destination having one or more location characteristics. In some examples, the target destination is a merchant location. The one or more location characteristics can include a type of merchant. In some examples, the one or more location characteristics can include a geographic location

In some examples, the computing device can generate navigation directions from an origin location to the target destination. In some examples, the navigation directions include a route from a first location to the target destination. The route can be displayed in a user interface to the user and/or turn-by-turn directions can be generated and presented (e.g., audibly or visually).

In some examples, the computing device can, at 704, determine a user inconvenience score for the target destination based on the one or more location characteristics. In some examples, the user inconvenience score can be based, at least in part, on a distance between the target destination and the user computing device.

The one or more location characteristics can include a level of busyness and wherein the user inconvenience score is based, at least in part, on the level of busyness associated with the target destination. The one or more location characteristics can include the hours of operation associated with the target destination. The user inconvenience score can be based, at least in part, on the hours of operation and an estimated time of arrival associated with the user computing device.

In accordance with a determination that the user inconvenience score exceeds a predetermined threshold, the computing device can, at 706, identify one or more alternative destinations. In some examples, the one or more alternative destinations are commercial locations (e.g., stores and/or merchants) and the computing device identifies one or more alternative merchants with a matching type of merchant.

In some examples, the computing device can, at 708, determine a user inconvenience score for each of the one or more alternative destinations. The user inconvenience score for each respective alternative destination in the one or more alternative destinations can be based, at least in part, on the type of merchant associated with each respective alternative destination in the one or more alternative destinations. In some examples, the computing device can, at 710), select, based on user inconvenience score for each of the one or more alternative destinations, a second destination from the one or more alternative destinations.

In some examples, the computing device determines whether an alternative destination in the one or more alternative destinations has an associated user inconvenience score below the user inconvenience score associated with the target destination. The computing device can select an alternative destination from the one or more alternative destinations with a lowest user inconvenience score.

Once an alternative location is determined, the computing device can, at 712, transmit the second destination for display to a user. After transmitting the second destination for display to a user, the computing device can receive information indicating user acceptance of the displayed second destination. In response to receiving user acceptance of the displayed second destination, the computing device generates navigation directions from an origin location to the second destination.

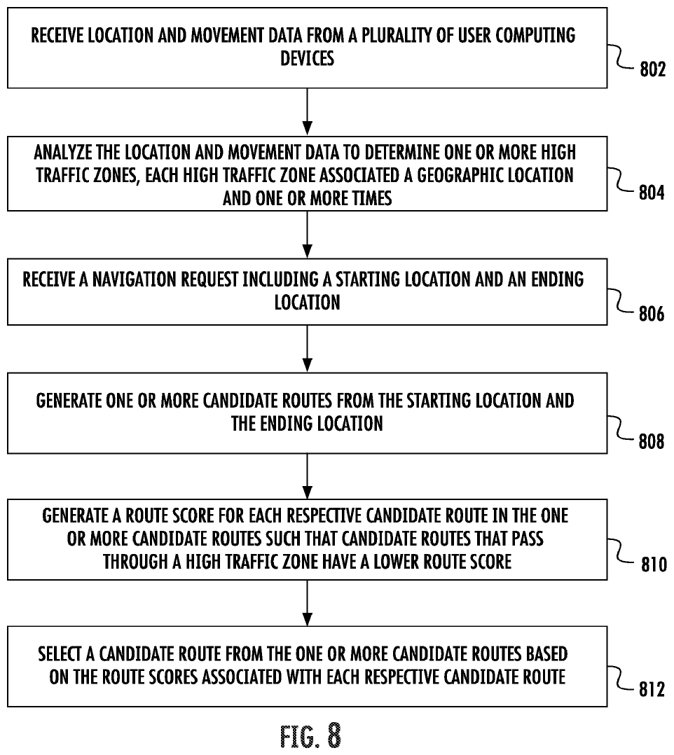

FIG. 8 depicts an example flow diagram for a method of determining high traffic zones and providing customized navigation information according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing device (e.g., computing device 100 in FIG. 1) can include one or more processors, memory, and other components that, together, enable the computing device to determine the time and position of high-traffic zones. In some examples, the computing device is a portable computing device, such as a smartphone or tablet computer. The computing device can receive, at 802, location and movement data from a plurality of user computing devices.

The computing device can analyze, at 804, the location and movement data to determine one or more high traffic zones, each high traffic zone being associated with a geographic location and one or more times. In some examples, the computing device determines, for each user computing device, an event associated with the user computing device. For example, the event can be a concert, sporting event, demonstration, and so on. In other examples, the event can be a recurring event such as the hours of a school or store.

In some examples, for a respective recurring event, the computing device can analyze the location and movement data from one or more users associated with the respective recurring event to determine a recurring high traffic zone associated with the event. The computing device can, at 806, store data representing the recurring high traffic zone based on the event. In some examples, the event is associated with a school.

In some examples, the computing device can, at 806, receive a navigation request including a starting location and an ending location. The computing device can, at 808, generate one or more candidate routes from the starting location and the ending location. These candidate routes can be generated based on geographic data stored in a geographic data store.

In some examples, the computing device can, at 810, generate a route score for each respective candidate route in the one or more candidate routes such that candidate routes that pass through a high traffic zone have a lower route score. For example, a route score can be generated based on the total distance traveled, the estimated amount of time needed to follow the route, the type of transportation, and so on. In some examples, any route that passes through a high-traffic zone can have its score adjusted to be lower.

The computing device can, at 812, select a candidate route from the one or more candidate routes based on the route scores associated with each respective candidate route. For example, the computing device can select the route with the highest or most improved score for presentation to the user.

The technology discussed herein makes reference to sensors, servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing device, the computing device comprising:
one or more processors,
a non-transitory computer-readable memory; wherein the non-transitory computer-readable memory stores instructions that, when executed by the one or more processors, cause the computing device to perform operations, the operations comprising:
receiving location and movement data from a plurality of user computing devices;
analyzing the location and movement data to determine one or more high traffic zones, each high traffic zone associated with a geographic location and one or more times;
receiving a navigation request including a starting location and an ending location;
generating one or more candidate routes from the starting location and the ending location; and
determining, for each respective candidate route in the one or more candidate routes, whether the respective candidate route passes through a high traffic zone; and
selecting a candidate route from the one or more candidate routes that does not pass through a high traffic zone.

2. The computing device of claim 1, wherein the operations further comprise:
determining, for each user computing device, an event associated with the user computing device.

3. The computing device of claim 2, wherein the determined event is a recurring event.

4. The computing device of claim 3, wherein the operations further comprise:
for a respective recurring event:
analyzing the location and movement data from one or more users associated with the respective recurring event to determine a recurring high traffic zone associated with the event; and
storing data representing the recurring high traffic zone based on the event.

5. The computing device of claim 2, wherein the determined event is associated with a school.

6. The computing device of claim 5, wherein the operations further comprise generating a route score for each respective candidate route in the one or more candidate routes such that candidate routes that pass through a high traffic zone have a lower route score; and
wherein the selecting a candidate route further comprises selecting a candidate route from the one or more candidate routes based, at least in part, on the route score.

7. The computing device of claim 1, wherein the route score represents a route efficiency of the candidate route, and wherein the candidate route is selected based on the candidate route having a highest route score.

8. A computing device, the computing device comprising:
one or more processors; and
a non-transitory computer-readable memory; wherein the non-transitory computer-readable memory stores instructions that, when executed by the one or more processors, cause the computing device to perform operations, the operations comprising:
receiving a navigation request to a target destination from a user computing device, the target destination having one or more location characteristics;
determining a user inconvenience score for the target destination based on the one or more location characteristics;
in accordance with a determination that the user inconvenience score exceeds a predetermined threshold, identifying one or more alternative destinations;
determining a user inconvenience score for each of the one or more alternative destinations;
selecting, based on the user inconvenience score for each of the one or more alternative destinations, a second destination from the one or more alternative destinations; and
transmitting the second destination for display to a user.

9. The computing device of claim 8, wherein the target destination is a merchant location.

10. The computing device of claim 9, wherein the one or more location characteristics include a type of merchant and wherein identifying one or more alternative destinations comprises:
identifying one or more alternative merchants with a matching type of merchant.

11. The computing device of claim 10, the user inconvenience score for each respective alternative destination in the one or more alternative destinations are based, at least in part, on the type of merchant associated with each respective alternative destination in the one or more alternative destinations.

12. The computing device of claim 8, wherein the one or more location characteristics include a geographic location and wherein the user inconvenience score is based, at least in part, on a distance between the target destination and the user computing device.

13. The computing device of claim 8, wherein the one or more location characteristics include a level of busyness and wherein the user inconvenience score is based, at least in part, on the level of busyness associated with the target destination.

14. The computing device of claim 8, wherein the one or more location characteristics include an hours of operation associated with the target destination and wherein the user inconvenience score is based, at least in part, on the hours of operation and an estimated time of arrival associated with the user computing device.

15. The computing device of claim 8, wherein selecting by the computing device and based on the user inconvenience score for each of the one or more alternative destinations, a second destination from the one or more alternative destinations further comprises:
determining, whether an alternative destination in the one or more alternative destinations has an associated user inconvenience score below the user inconvenience score associated with the target destination.

16. The computing device of claim 15, wherein selecting by the computing device and based on the user inconvenience score for each of the one or more alternative destinations, a second destination from the one or more alternative destinations further comprises:
selecting an alternative destination from the one or more alternative destinations with a lowest user inconvenience score.

17. The computing device of claim 8, wherein the operations further comprise:
generating, by the computing device, navigation directions from an origin location to the target destination.

18. The computing device of claim 8, wherein the operations further comprise:
after transmitting the second destination for display to a user, receiving, by the computing device, user acceptance of the displayed second destination; and
in response to receiving user acceptance of the displayed second destination, generating, by the computing device, navigation directions from an origin location to the second destination.

19. A non-transitory computer-readable medium storing instructions that, when executed by one or more computing devices, cause the one or more computing devices to perform operations, the operations comprising:
receiving a navigation request to a target destination from a user computing device, the target destination having one or more location characteristics;
determining a user inconvenience score for the target destination based on the one or more location characteristics;
in accordance with a determine that the user inconvenience score exceeds a predetermined threshold, identifying one or more alternative destinations;
determining a user inconvenience score for each of the one or more alternative destinations;
selecting, based on the user inconvenience score for each of the one or more alternative destinations, a second destination from the one or more alternative destinations; and
transmitting the second destination for display to a user.

20. The non-transitory computer-readable medium of claim 19, wherein the target destination is a merchant location.
